(19) United States
(12) Patent Application Publication
(10) Pub. No.: US 2005/0070268 A1
(43) Pub. Date: Mar. 31, 2005

(54) Method of testing RF circuit, and arrangement

(76) Inventors: Juha Hakkinen, Oulu (FI); Pekka Syri, Oulu (FI); Markku Moilanen, Oulu (FI)

Correspondence Address: Crawford Maunu PLLC, Suite 390, 1270 Northland Drive, St. Paul, MN, 55120, US

(21) Appl. No.: 10/674,728

(22) Filed: Sep. 30, 2003

(51) Int. Cl. H04B 1/00

(52) U.S. Cl. 455/423

(57) ABSTRACT

A test method and an arrangement for testing an RF circuit of a wireless device are provided. The test arrangement includes providing means connected to the RF circuit, the providing means for providing the RF circuit to be tested with an input test signal, thus generating an RF output test signal characterizing the response of the RF circuit, and down-converting means connected to the RF circuit and integrated at least partially into the RF circuit, the down-converting means for down-converting the RF output test signal to a BB frequency, thus generating a BB output test signal. The invention provides access to the RF circuit by using relatively simple test instrumentation operating at a base band frequency.

### FIELD

The invention relates to a method of testing a radio frequency circuit and to an arrangement. Particularly, the invention relates to a method and arrangement for testing a radio frequency circuit of a wireless device.

### BACKGROUND

Reliable, accurate, fast and cost-efficient testing of products is one of the corner stones of the modern electronics industry producing electronic devices, such as wireless devices, in mass production. Especially, the testing of radio frequency (RF) circuits of wireless devices presents a great challenge in terms of reliability and cost efficiency.

The high integration level of RF circuits, especially that of RF integrated circuits, results in difficulties in accessing the device under test in the RF circuit.

According to prior art solutions, an apparatus external to the wireless device is connected to the device under test, and the RF output test signal is delivered into the apparatus for analysis. Such apparatuses are, however, expensive, slow in a mass production environment, and the test result may be unreliable due to the relatively long signal path of the RF output test signal between the device under test and the test apparatus. Therefore, it is desirable to consider improved techniques for testing RF circuits.

### BRIEF DESCRIPTION OF THE INVENTION

An object of the invention is to provide an improved method and arrangement for testing an RF circuit in a wireless device. According to an aspect of the invention, there is provided a method of testing an RF circuit of a wireless device of a telecommunications system, the method including: providing the RF circuit to be tested with an input test signal, thus generating an RF output test signal characterizing the response of the RF circuit; and down-converting the RF output test signal to a BB frequency by using a test structure integrated at least partially into the RF circuit, thus generating a BB output test signal.

According to another aspect of the invention, there is provided an arrangement for testing an RF circuit of a wireless device of a telecommunications system, the arrangement including: providing means connected to the RF circuit, the providing means for providing the RF circuit to be tested with an input test signal, thus generating an RF output test signal characterizing the response of the RF circuit; and down-converting means connected to the RF circuit and integrated at least partially into the RF circuit, the down-converting means for down-converting the RF output test signal to a BB frequency, thus generating a BB output test signal.

Preferred embodiments of the invention are described in the dependent claims.

The method and system of the invention provide several advantages. The integration of the down-converter performing a down-conversion of the output test signal from a radio frequency into a base band frequency provides an access to the RF circuit by using relatively simple test instrumentation. As a result, the RF circuit is virtually a low-frequency component from the viewpoint of the external instrumentation, and standardized test structures, such as IEEE 1149.4 may be used in test procedures. The invention further provides a platform for performing self-test procedures, such as Build-In-Self-Test.

### LIST OF DRAWINGS

In the following, the invention will be described in greater detail with reference to the preferred embodiments and the accompanying drawings, in which

FIG. 1 shows a first example of the structure of a test arrangement according to embodiments of the invention;

FIG. 2 shows a second example of the structure of a test arrangement according to embodiments of the invention; and

FIG. 3 shows an example of the structure of a test signal generator according to an embodiment of the invention;

FIG. 4 shows an example of the structure of a down-converter unit according to an embodiment of the invention, and

FIG. 5 illustrates methodology according to embodiments of the invention by means of a flow chart.

### DESCRIPTION OF EMBODIMENTS

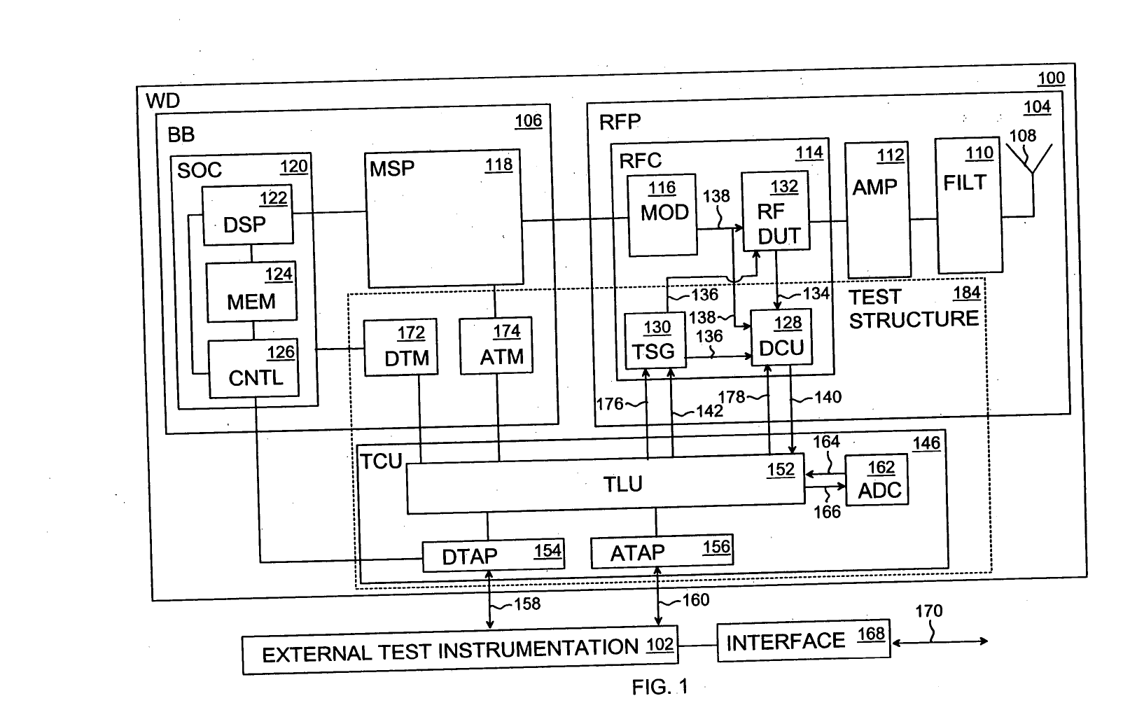

With reference to FIG. 1, let us examine embodiments of the test arrangement for testing a radio frequency (RF) circuit by means of an exemplified test arrangement.

The exemplified test arrangement includes a wireless device 100 and external test instrumentation 102. The structure and operation of the wireless device and the test instrumentation are known to a person skilled in the art and only details relevant to the invention are described.

The wireless device (WD) may also be called terminal equipment, a cellular phone, a mobile phone, a mobile terminal, and mobile equipment. In a broad sense, the wireless device is a piece of equipment capable of communicating with a communication network of a telecommunications system by using a radio frequency air interface.

In testing, the wireless device is typically subjected to a test procedure typically resulting in a test result, which characterizes the quality of the device being tested. The test results may be used in assessing the quality of the wireless device and possibly the rejection of the wireless device from entering the market. The test result may also be used in calibration, tuning, and maintaining the wireless device. Thus, the term “testing” may cover production testing, calibration, tuning, and maintenance testing.

Testing may be performed at different stages of the life span of the wireless device. Testing may be performed during the manufacture of the wireless device. Testing may also be performed after the wireless device has entered the market. In this case, testing may be carried out in a service facility or while the wireless device is in regular use. The latter corresponds to a build-in self-test (BIST) embodiment of the invention.

In tuning, the RF circuit of the wireless device is typically subjected to a series of testing and adjusting steps until the test result falls in an acceptable region. The adjusting of the RF circuits is known one skilled in the art.

The exemplified wireless device 100 may include a radio frequency part (RFP) 104 and a base band part (BB) 106. The radio frequency part 104 may include an antenna unit 108 for performing a conversion between an electric antenna signal and an electromagnetic field carrying the radio frequency signals between the wireless device 100 and the communication network.

The radio frequency part 104 may further include a filter unit 110, such as a duplex filter, connected to the antenna unit 108 for attenuating undesired frequency components from antenna signals.

The radio frequency part 104 may further include an amplifier unit 112 for amplifying transmit and receive radio frequency signals. The receive portion of the amplifier unit 112 may be implemented with a low-noise amplifier, for example. The transmit portion of the amplifier unit 112 may be implemented by using a linear power amplifier, for example.

The radio frequency part 104 includes functionalities associated with radio frequency signals. However, the radio frequency part 104 may show signals, such as control signals, oscillating at low frequencies.

The radio frequency part 104 typically includes at least one RF circuit (RFC) 114, which may include integrated structures, such as RF ASIC (Application Specific Integrated Circuit). The radio frequency circuit 114 may also include discrete components, such as resistors, capacitors, coils, and their combinations. Any electric component, which outputs radio frequency signals as a response to an input test signal, may be subjected to testing.

The RF circuit 114 may include a modulator unit 116 for up-converting a low frequency transmit signal, such as a base band transmit signal or an intermediate frequency transmit signal, into a transmit radio frequency signal. The modulator unit 116 may further convert a radio frequency receive signal into a low-frequency receive signal, such as an intermediate frequency receive signal or a base band receive signal.

The RF circuit 114 may further include means, such as a phase locked loop, for generating radio frequency signals with predefined characteristics. Such radio frequency signal may be used, for example, for performing conversion between a radio frequency signal and low-frequency signals.

The base band part 106 may include a mixed signal part (MSP) 118 and a system-on-chip (SOC) 120. The mixed signal part 118 may perform tasks both in the digital and the analog domain.

The system-on-chip 120 may be implemented with a digital signal processor (DSP) 122 and memory means 124, such as ROM (Read-Only-Memory). The basic structure and operation of the digital signal processor 122 and those of the memory means 124 are known to a person skilled in the art, and only details relevant to the invention are disclosed.

The functional units, such as the antenna unit 108, the amplifier unit 112, the RF circuit 114, the mixed signal part 118, and the system-on-chip 120, may be implemented by using separate micro chips placed on a common printed board. However, the invention is not restricted to the presented division, but the functional units may be distributed freely to microchips. For example, the base band part 106 and the radio frequency part may be placed on a single microchip.

The exemplified RF circuit 114 includes at least one RF device 132 under test (RF DUT). The RF device 132 is characterized by an RF output test signal 134 obtained as a response to an input test signal 136, 138 provided to the RF device under test 132.

The RF output test signal 134 is delivered to a down-converter unit (DCU) 128, which down-converts the RF output test signal 134 into a base band (BB) output test signal 140. The down-converter unit (DCU) 128 is at least partially integrated into the RF circuit 114, thus providing integrated access to the RF device 132.

The integrated structure of the down-converter unit 128 provides advantages, such as a relatively short distance between the down-converter unit 128 and the RF device 132, thus enabling a reliable RF signal delivery from the RF device 132 to down-converter unit 128.

The down-converter unit 128 may support standardized input and output signal traffic between the down-converter unit 128 and the test control unit 146. The standard may be based on boundary scan test architectures, such as those defined by standard IEEE 1149.4, “Standard for a Mixed Signal Test Bus”, IEEE, USA, 1999, which is thereby incorporated by reference.

The conversion of the output test signal 134 from the radio frequency to a BB frequency enables the use of low-frequency test instrumentation for determining the response of the RF device 132 to the input test signal. Furthermore, the throughput of a test line may be improved, since the requirements of the interface between the wireless device 100 and the external test instrumentation 102 may be lowered.

In an embodiment, the arrangement includes a test control unit 146 for providing access to the RF circuit 114. The access includes inputting signals into the RF circuit 114 and outputting signals from the RF circuit 114. The access may further include routing the signals between the RF circuit 114 and input/output buses of the test control unit 146.

In an embodiment, the test control unit 146 provides access to the RF circuit 114 in order to probe the RF output test signal. The actual probe is performed by the down-converter unit 128.

The down-converter unit 128 may be provided with a control signal 178 by the test control unit 146, which control signal 178 may be used to configure the down-converter unit 128 according to requirements defined by the RF output test signal 134 and the BB output test signal 140. The control signal 178 may further provide a reference frequency for the down-converter unit 128, which reference frequency is used in the down-conversion.

The base band output signal 140 is delivered to a test control unit (TCU) 146, which, controls the test arrangement, for example. The test control unit 146 may include a test logic unit (TLU) 152, which manages the routing of the BB input test signal 142 to a test signal generator 130 and the BB output test signal 140 from a desired RF device 132 to a desired output test access port of the test control unit 146. The test control unit 146 may be implemented with binary registers, memory means, buses and a processing unit. A detailed structure of a test control unit 146 can be found in the cited IEEE 1949.4 standard, for example.

The test access port may be a digital test access port 154 (DTAP) relaying digital signals 158 between the test arrangement and the external test instrumentation 102. The digital signals 158 may include control signals, such as timing signals, and clock signals, digital input test signals, and digital output test signals.

The digital test access port 154 may further be connected to the BB test control unit 126, which controls internal test procedures of the wireless device, such as BIST (Build-In-Self-Test).

If the output test signal is required in a digital format, the test arrangement may be equipped with an analog-to-digital converter 162, which converts the analog output test signal 164 into a digital output test signal 166.

The test access port may also be an analog test access port 156 (ATAP) relaying analog signals 160 between the test arrangement and the external test instrumentation 102. The analog signals 160 may include analog BB input test signals and BB analog output test signals.

The input test signal 136, 138 provides a stimulus for the RF device 132, which stimulus results in the RF output test signal 134, which characterizes the response of the RF device 132 to the stimulus. The characteristics, such as the frequency, voltage and the current of the input test signal 136, 138 depend on the requirements of the RF device 132 and the requirements of the test. The characteristics may be controlled with a test control signal 176 provided by the test control unit 146 for the test signal generator 130.

The characteristics of the response of the RF device 132 to the input test signal 136 depend on the embodiment. The input test signal 136 may be a control signal inputted into the RF device 132, which control signal affects the operation of the RF device such that the RF output test signal 134 is altered. In mathematical terms, the response may be represented by R and may be written as
R=R(sₒ,sᵢ) (1)
wherein R is the response function, sᵢ is proportional to a parameter of the input test signal, and sₒ is proportional to a parameter of the RF output test signal 134. The parameters may characterize for example a frequency, a phase, a voltage or a current of the input test signal 136 and the output test signal 134.

The response R may be determined in the BB test control unit 126 or in the external test instrumentation 102 by using a computer and software. The response may be interpreted as a test result 170, which may further be communicated to the user of the wireless device, the production line, or repair personnel. The test result 170 may be communicated over an interface unit 168 connected to the external test instrumentation 102, or over the air interface of the communication network.

In an embodiment, a portion of the input test signal 136, 138 is delivered to the down-converter unit 128, which down-converts the input test signal 136, 138 to the BB frequency. The BB input test signal 136, 138 may further be delivered to the test control unit 146, which routes the BB input test signal 136, 138 to the external test instrumentation 102 or to the BB test control unit 126. In this embodiment, the characteristics of the input test signal 136, 138 may be determined by a measurement. The response of the RF device 132 to the input test signal 136, 138 may be determined by carrying out a comparison between the measurement of the input test signal 136, 138 and the RF output test signal 134.

In an embodiment, the test arrangement may further perform the testing of a digital circuit of the wireless device. In such a case, the test arrangement includes at least one digital test module (DTM) 172 connected to the test control unit 146. In the exemplified case shown in FIG. 1, the digital test module 172 is connected to the system-on-chip 120. The digital test module 172 may, however, be used for testing a digital device anywhere in the wireless device. The structure and operation of the digital test module 172 are known to a person skilled in the art. In an embodiment, the digital test module 172 is a Digital Boundary Module (DBM) according to standard IEEE 1149.1 “IEEE Standard Test Access Port and Boundary Scan Architecture”, IEEE USA 2001, which is thereby incorporated by reference.

In an embodiment, the test arrangement may further perform the testing of an analog circuit of the wireless device. In such a case, the test arrangement includes at least one analog test module (ATM) 174 connected to the test control unit 146. The structure and operation of an analog test module 174 are known to a person skilled in the art, and will not be discussed in detail. In an embodiment, the analog test module 174 is an Analog Boundary Module (ABM) according to the standard IEEE 1149.4.

The input test signal 136 may characterize an actual RF signal propagating in a signal path in the RF circuit. In such a case, the frequency and bandwidth of the input test signal 136, 138 may match those of the actual RF signal.

The frequency spectrum of the input test signal 136 may be discrete or continuous, including, for example, harmonics of a basic frequency. An input test signal, which includes a plurality of frequencies, may also be called a multi-tone test signal.

In an embodiment, the input test signal 136 is provided by a test signal generator 130 (TSG) connected to the RF circuit 114 and the test control unit 146. The test signal generator 130 may act like an analog boundary module between the test control unit 146 and the RF device 132. The test signal generator 130 may further be configured to generate the input test signal 136 at a radio frequency.

In an embodiment, the input test signal 138 is provided by the transmission chain including the modulator unit 116 of the wireless device.

The testing method and the arrangement may be applied to test different RF devices and RF device characteristics, such as the modulation produced by the modulator 116 and the bias current of a low-noise amplifier in the amplifier unit 112. The amplifier unit 112 may also be tested by determining a ratio between the input current characterized by the input test signal and an output current characterized by the RF output test signal.

The method and arrangement may be applied to interconnect testing, i.e. to detect opens and shorts, to detect and diagnose bridging faults, and to perform a parametric test in RF circuits. The parametric test may be used, for example, in characterizing a portion of the RF circuit 114. The characterization may be used in adjusting the portion of the RF circuit 114 to operate in a desired manner.

Furthermore, the method and arrangement may be applied to compensate for effects from changes in thermal and pressure conditions in the RF circuit.

In an analog test, characterization measurement and testing for the presence and value of discrete components and larger portions of RF circuits may be made. The wiring and characteristics of the input test signal 136 and the RF output test signal 134 to the RF device 132 are known to a person skilled in the art, and are therefore not shown. In a broad sense, the term “testing” may cover production testing, calibration, tuning and maintenance testing.

Each RF device 132 may or may not have a device-specific down-converter unit 128. If the same down-converter unit 128 is used in a plurality of RF devices 132, switching means and a routing logic for accessing a desired RF device 132 may be required between the plurality of the RF devices. 132 and the down-converter unit 128.

In an embodiment, the RF device 132 is a voltage controlled oscillator (VCO) of a phase locked loop, for example. In such a case, the input test signal 136 provides a direct current control voltage for the voltage controlled oscillator. The RF output test signal 134 in this case characterizes the output signal of the voltage controlled oscillator.

The voltage controlled oscillator may be characterized by determining parameters, such as those characterizing the linearity of the adjustment of the voltage controlled oscillator, amplification parameters, delta modulation, and the output power as a function of the control voltage provided by the input test signal 136. The parameters may be used, for example, in tuning the voltage controlled oscillator to operate in a desired manner.

The frequency range division into a base band frequency region and a radio frequency region depends on the application. The base band frequency typically falls to a frequency region below 100 kHz, and is not restricted to frequencies applied in the base band part 106 of the wireless device. The base band frequency may also be called a low frequency.

The radio frequency region covers a frequency range from hundreds of kHz to several GHz. The radio frequencies used for providing the air interface in a telecommunications system usually fall between hundreds of MHz to several GHz. For example, GSM (Global System for Mobile Communications) applies radio frequencies between 850 MHz (GSM850) to 1900 MHz (GSM1900). UMTS (Universal Mobile Telecommunications System) may apply a radio frequency band with a central frequency at about 2 GHz. The invention is not, however, restricted to the presented figures, but may be applied to any radio frequency, which is convertible to a base band frequency.

The down-converter unit 128, the test signal generator 130, the digital test module 172, the analog test module 174, the digital test access port 154, and the analog test access port 156 form a test structure 184 shown with a dashed block. The test structure 184 may be based on a standardized architecture, such as IEEE 1194.4.

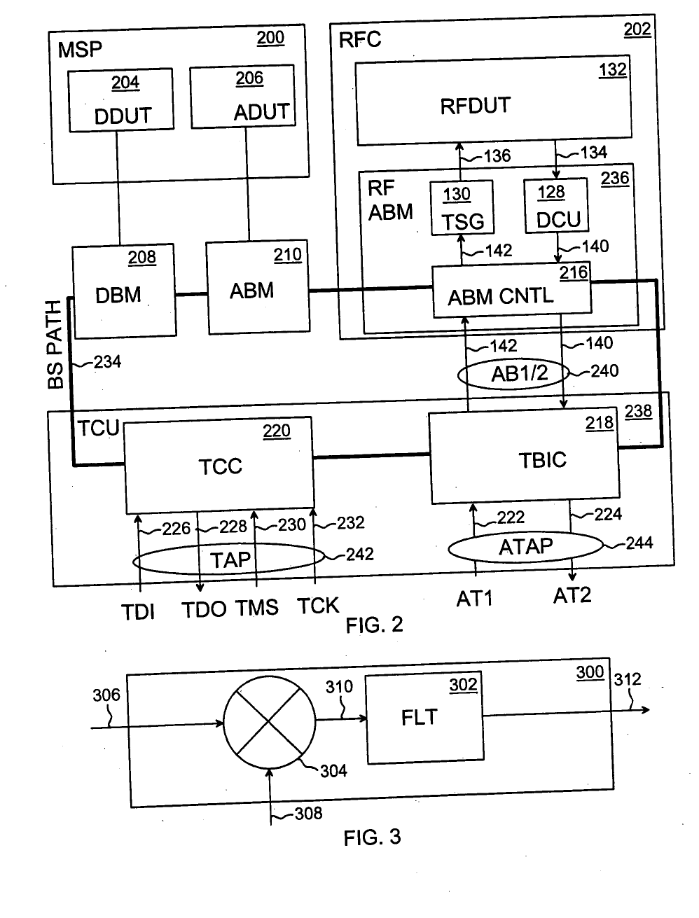

With reference to FIG. 2, an example of the test arrangement based on the IEEE 1194.4 standard is shown. The mixed signal part 200 includes a digital device 204 under test (DDUT) and a BB analog device 206 under test (ADUT). The digital device 204 and the BB analog device 206 are probed by a Digital Boundary Module 208 (DBM) and an Analog Boundary Module 210 (ABM), respectively.

The RF circuit 202 may include an RF Analog Boundary Module 236, which includes the test signal generator 130 and the down-converter unit 128.

The exemplified test control unit 238 may include Test Control Circuitry 220, which may include a test access port controller, instruction register, and a decoder now shown in FIG. 2. The Test Control Circuitry 220 may be connected to a Test Access Port 242 and may provide digital access to the RF Analog Boundary Module 236. The Test Control Circuitry 220 may receive a digital test data signal 226, a digital test mode select signal 230, and a test clock signal 232, communicated through a Test Data Input pin (TDI), a Test Mode Select (TMS) pin, and a Test Clock (TCK) pin, respectively, connected to the external test instrumentation 102 and/or to the BB test control unit 126. The Test Control Circuitry 220 may output a digital test data output signal 228 communicated through a Test Data Output (TDO) pin connected to the external test instrumentation 102 and/or to the BB test control unit 126. The detailed structure and format of the Test Control Circuitry may be found in IEEE 1149.1 standard.

The exemplified test control unit 238 may include a Test Bus Interface Circuit 218, which provides analog access to the RF Analog Boundary Module 236. The Test Bus Interface Circuit 218 is equipped with an Analog Test Access Port (ATAP) 244, which includes a first analog test pin (AT1) and a second analog test pin (AT2) for relaying a first analog signal 222 and a second analog signal 224, respectively, between the Test Bus Interface Circuit 218 and the external test instrumentation 102, for example.

The test control unit 238 may communicate with the boundary modules 208, 210 and 236 through a Boundary Scan Path 234. The test control unit 238 may send a control word to the boundary scan path 234, which control word configures a desired boundary module to perform an RF measurement, i.e. the down-conversion for the RF output signal from the RF device 132. The test control word may be inputted into the Test Data Input pin, for example.

The control word may further activate the desired boundary module to switch to the Analog Test Access Port 244 in order to deliver the BB output test signal 140 to the external test instrumentation 102, for example.

The RF Analog Boundary Module 236 may further include an ABM controller 216, which may contain a control register, an update register and control logic.

The Test Bus Interface Circuit 218 may be connected to the RF Analog Boundary Module through an Internal Analog Test Bus (AB1/2) 240. The Test Bus Interface Circuit 218 may connect the Internal Analog Test Bus 240 to the Analog Test Access Port 244, thus providing a connection from the pins AT1 and AT2 of the Analog Test Access Port 244 to the RF Analog Boundary Module 236. In an embodiment of the invention, the BB input test signal 142 is proportional to the first analog signal 222, and the second analog signal 224 is proportional to the BB output test signal 140. The first analog signal 222 and the second analog signal 224 may oscillate at a BB frequency or they may be DC signals. Therefore, they may be connected to the external test instrumentation 102 by using wiring and buses designed for low-frequency signals.

With reference to FIG. 3, the test signal generator 300 may include an up-mixer 304 for up-converting the BB input into test signal 306 into a radio frequency. The up-mixer 304 may be inputted a reference frequency 308, which is mixed with the BB input test signal 306, thus resulting in a mixed RF signal 310. The reference frequency 308 may be a local oscillator frequency, for example.

The mixed RF signal 310 includes frequency components, which are typically arithmetic sums and/or differences of the frequency of the BB input test signal 306 and the reference frequency 308. The mixed RF signal 310 may be delivered to a filter unit 302, such as a high-pass filter, for attenuating the undesired frequency components from the mixed RF signal 310. As a result of filtering, the RF input test signal 312 is produced. The test signal generator 300 may be constructed by an average skilled person by using available electric components.

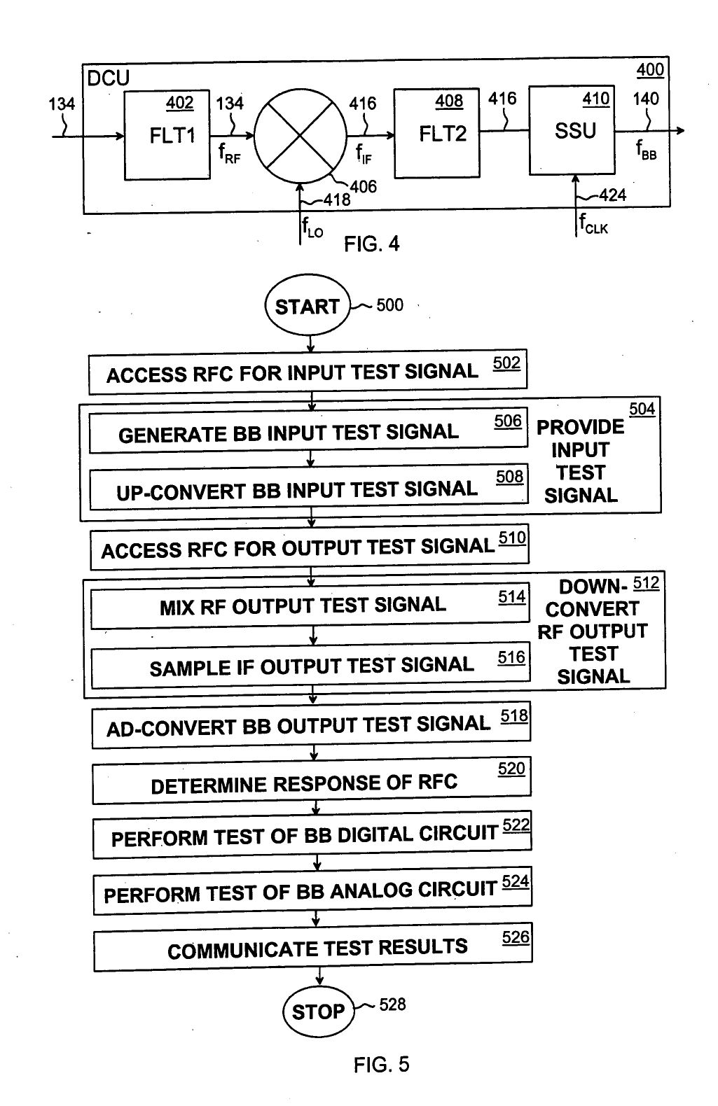

With reference to FIG. 4, the down-converter unit 400 may include a first filter 402, such as a band-pass filter, for attenuating undesired frequency components from the RF output test signal 134. After filtering, the RF output test signal 134 may be delivered to a down-mixer 406, which mixes the RF output test signal 134 with a pre-defined reference frequency 418, thus generating an IF output test signal 416. The IF output test signal 416 may further be delivered to a sub-sampling unit 410, which samples the IF output test signal 416 with a sampling rate lower than the frequency of the IF output test signal 416, thus producing the BB output test signal 140 in an analog format. The sampling rate may be defined by a clock signal 424 provided by the test control unit 146, for example. In an embodiment, a second filter 408, such as a band-stop filter, for attenuating the undesired frequency components from the IF output test signal 416 may be placed between the down-mixer 406 and the sub-sampling unit 410. The pre-defined reference frequency 418 may be obtained, for example, from a local oscillator of the wireless device. In an embodiment, the RF Analog Boundary Module 236 includes an integrated voltage controlled oscillator, thus reducing the need to deliver the pre-defined reference frequency 418 from outside the RF Analog Boundary Module 236. The down-mixer 406 and the filters 402 and 408 may be implemented with components known to a person skilled in the art.

The sub-sampling unit 410 may be implemented with a switch that connects the output of the down-converter unit 400 to the down-mixer 406 or the second filter 408 at the given sampling rate. The sub-sampling unit 410 may further include an amplifier, such as an operational amplifier, for amplifying the BB output test signal 140. In an embodiment, the switch of the sub-sampling unit may be implemented by using the switches and the associated control structure of the standardized test structure.

The down-conversion from the RF output test signal to the BB output signal may be expressed in mathematical terms by denoting the RF output test signal frequency with f_{RF}, the predefined reference frequency with f_{LO}, the clock signal frequency with f_{CLK}, and the BB output test signal frequency with f_{BB}. The RF output test signal frequency f_{RF} may be written as
f_{RF}=f_{BB}+f_{LO}+nf_{CLK}, (2)
wherein n is an integer.

In an exemplified case, f_{RF}=2.000 GHz, f_{LO}=1.900 GHz, f_{IF}=100 MHz, f_{BB}=50 KHz, and f_{CLK}=9.995 MHz. The above figures represent a case, wherein an RF device 132 operating at a 2 GHz frequency may be tested by using a test structure and external test instrumentation 102 operating at 50 kHz frequency.

With reference to FIG. 5, embodiments of the methodology of the invention are shown with a flow chart presentation.

In 500, the method is started.

In 502, the RF circuit is accessed with a standardized boundary scan test structure in order to probe the RF output test signal.

In 504, the RF circuit 114 is provided with an input test signal. 136.

In 506, the BB input test signal 136 is generated.

In 508, the BB input test signal 136 is up-converted into a radio frequency.

In 510, the RF circuit is accessed with a standardized boundary scan test structure in order to provide the input test signal into the RF circuit.

In 512, the RF output test signal 134 is down-converted to a BB frequency.

In 514, the RF output test signal 136 is mixed with a predefined reference frequency 418, and an IF output test signal 416 is generated.

In 516, the IF output test signal 416 is sampled with a sampling rate lower than the frequency of the IF output test signal 416.

In 518, the BB output test signal 140 is AD-converted from an analog format into a digital format.

In 520, the response of the RF circuit 114 to the input test signal 134 is determined by using the BB output test signal 140, in order to obtain a test result.

In 522, testing of a digital circuit of the wireless device is performed.

In 524, testing of an analog circuit of the wireless device is performed.

In 526, the test results are communicated to a production line producing the wireless device.

In 528, the method is stopped.

Even though the invention is described above with reference to an example according to the accompanying drawings, it is clear that the invention is not restricted thereto but it can be modified in several ways within the scope of the appended claims.

1. A method of testing an RF circuit of a wireless device of a telecommunications system, the method including:
providing the RF circuit to be tested with an input test signal, thus generating an RF output test signal characterizing the response of the RF circuit; and
down-converting the RF output test signal to a BB frequency by using a test structure integrated at least partially into the RF circuit, thus generating a BB output test signal.

2. The method of claim 1, further including accessing the RF circuit with a standardized boundary scan test structure in order to probe the RF output test signal.

3. The method of claim 1, further including accessing the RF circuit with a standardized boundary scan test structure in order to provide the input test signal into the RF circuit.

4. The method of claim 1, further including: mixing the RF output test signal with a pre-defined reference frequency, thus generating an IF output test signal; and
sampling the IF output test signal with a sampling rate lower than the frequency of the IF output test signal, thus producing the BB output test signal in an analog format.

5. The method of claim 1, further including AD-converting the BB output test signal from an analog format into a digital format.

6. The method of claim 1, further including: generating a BB input test signal; and
up-converting the BB input test signal into a radio frequency, thus generating the input test signal at a radio frequency.

7. The method of claim 6, further including up-converting the BB input test signal into the radio frequency in an Analog Boundary Module.

8. The method of claim 1, further including down-converting the RF output test signal in an Analog Boundary Module.

9. The method of claim 1, wherein the test structure is based on a standardized boundary scan architecture.

10. The method of claim 1, wherein the test structure includes at least one element in a group comprising: a Test Control Circuitry, a Test Bus Interface Circuit, a Test Access Port, an Analog test Access Port, an Analog Boundary Module, Digital boundary module.

11. The method of claim 1, further including determining the response of the RF circuit to the RF input test signal by using the BB output test signal in order to obtain a test result.

12. The method of claim 11, further including communicating the test result to a production line producing the wireless device.

13. The method of claim 1, further including performing a testing of a digital circuit of the wireless device with the test structure.

14. The method of claim 1, further including performing a testing of a BB analog circuit of the wireless device with the test structure.

15. An arrangement for testing an RF circuit of a wireless device of a telecommunications system, the arrangement including:
providing means connected to the RF circuit, the providing means for providing the RF circuit to be tested with an input test signal, thus generating an RF output test signal characterizing the response of the RF circuit; and
down-converting means connected to the RF circuit and integrated at least partially into the RF circuit, the down-converting means for down-converting the RF output test signal to a BB frequency, thus generating a BB output test signal.

16. The arrangement of claim 15, further including first accessing means connected to the down-converting means, the first accessing means for accessing the RF circuit in order to probe the RF output test signal.

17. The arrangement of claim 15, further including second accessing means connected to the providing means, the second accessing means for accessing the RF circuit in order to provide the input test signal for the RF circuit.

18. The arrangement of claim 15, further including: mixing means connected to the RF circuit, the mixing means for mixing the RF output test signal with a pre-defined reference frequency, thus generating an IF output test signal; and
sampling means connected to the mixing means, the sampling means for sampling the IF output test signal with a sampling rate lower than the frequency of the IF output test signal, thus producing the BB output test signal in an analog format.

19. The arrangement of claim 15, further including AD-converting means operationally connected to the down-converting means, the AD-converting means for AD-converting the BB output test signal from an analog format into a digital format.

20. The arrangement of claim 15, further including: generating means for generating a BB input test signal; and
up-converting means connected to the RF circuit and the generating means, the up-converting means for up-converting the BB input test signal into a radio frequency, thus generating the input test signal at a radio frequency.

21. The arrangement of claim 20, wherein the up-converting means is located in an Analog Boundary Module integrated into the RF circuit.

22. The arrangement of claim 15, wherein the down-converting means is located in an Analog Boundary module integrated into the RF circuit.

23. The arrangement of claim 16, wherein the first accessing means includes at least one element in a group comprising: a Test Control Circuitry, a Test Bus Interface Circuit, a Test Access Port, an Analog test Access Port, an Analog Boundary Module, Digital boundary module.

24. The arrangement of claim 17, wherein the second accessing means includes at least one element in a group comprising: a Test Control Circuitry, a Test Bus Interface Circuit, a Test Access Port, an Analog test Access Port, an Analog Boundary Module, Digital boundary module.

25. The arrangement of claim 15, further including: determining means operationally connected to the down-converting means, the determining means for determining the response of the RF circuit to the input test signal by using the BB output test signal in order to obtain a test result.

26. The arrangement of claim 25, further including communicating means operationally connected to the determining means, the communicating means for communicating the test result to a production line producing the wireless device.

27. The arrangement of claim 15, further including first performing means for performing testing of a digital circuit of the wireless device.

28. The arrangement of claim 15, further including second performing means for performing testing of a BB analog circuit of the wireless device.
